(19) United States
(12) Patent Application Publication
(10) Pub. No.: US 2009/0262496 A1
(43) Pub. Date: Oct. 22, 2009

(54) HEAT DISSIPATING STRUCTURE OF AN INDUSTRIAL COMPUTER

(75) Inventors: Te-Chieh Chiu, Taipei (TW); Chih-Ming Wu, Taipei County (TW)

Correspondence Address: ROGER H. CHU, 19499 ERIC DRIVE, SARATOGA, CA, 95070, US

(73) Assignee: NEXCOM INTERNATIONAL CO., LTD., Chung-Ho (TW)

(21) Appl. No.: 12/104,527

(22) Filed: Apr. 17, 2008

(51) Int. Cl. G06F 1/20

(52) U.S. Cl. 361/679.48

(57) ABSTRACT

The present invention discloses an improved heat dissipating structure of an industrial computer, and the heat dissipating structure includes a heat dissipating module and two fixing units installed on both lateral sides of a top surface of the heat dissipating module, and the heat dissipating module includes a detachable heat dissipating fan module disposed therein, and the fixing unit is secured integrally with the heat dissipating module and the industrial computer by a plurality of fixing elements to achieve the effect of facilitating the change of a heat dissipating fan module.

### FIELD OF THE INVENTION

The present invention relates to a heat dissipating structure of an industrial computer, and more particularly to an improved heat dissipating structure that facilitates changing a heat dissipating fan module in an industrial computer.

### BACKGROUND OF THE INVENTION

In general, a major difference between an industrial computer and a personal computer resides on that the appearance of the personal computer can be designed with changes according to the consumer requirement and preference, and the industrial computer must be designed in accordance with other equipments for an automated operation and in compliance with the requirements of saving working spaces and avoiding a large ineffective working space, and thus most industrial computers come with an appearance of a cuboid having fixed length and width and a height equal to an integral multiple of a universal standard. Since the industrial computers produce a large quantity of heat during their operation, the cuboidic casing of the industrial computer generally includes a heat dissipating module comprised of heat dissipating fins and fans for dissipating the heat. Due to the short life expectancy of a fan or the attachment of dusts from the air, the fan may fail or have a poor efficiency easily after being used for a while. Thus, users have to turn off the industrial computer and remove the casing before changing the fan or clean the dusts on the fan. Obviously, such arrangement is very inconvenient to users. Furthermore, vibrations may be produced during the operation of the heat dissipating fans and bad tracks may be produced by the vibrations when accessing a hard disk of the industrial computer, and the bad tracks will affect the overall operation of the industrial computer. Therefore, the aforementioned design of a general industrial computer with an installed heat dissipating module is unable to meet the requirements of the application.

As described above, it is an important subject for manufacturers and designers to develop a heat dissipating structure that provides an easy and convenient way of installing the heat dissipating module and preventing the vibrations produced by the heat dissipating fans or the adverse effects on the industrial computer without affecting the heat dissipation of the industrial computer.

### SUMMARY OF THE INVENTION

It is a primary objective of the present invention to provide an improved heat dissipating structure of an industrial computer that can achieve the effect of changing the heat dissipating structure easily without affecting the heat dissipation of the industrial computer.

To achieve the foregoing objective, the present invention provides an improved heat dissipating structure of an industrial computer, comprising: a heat dissipating module and two fixing units installed on both lateral sides of a top surface of the heat dissipating module, and the heat dissipating module includes a detachable heat dissipating fan module therein, and the fixing unit is secured integrally with the heat dissipating module and the industrial computer by a plurality of fixing elements to facilitate a change of a heat dissipating fan module.

Another objective of the present invention is to provide an improved heat dissipating structure of an industrial computer to achieve a vibration-proof effect without affecting the heat dissipation of the industrial computer.

To achieve the foregoing objective, the present invention provides an improved heat dissipating structure of an industrial computer, comprising: a heat dissipating module and two fixing units installed on both lateral sides of a top surface of the heat dissipating module, and the heat dissipating module includes a detachable heat dissipating fan module therein, and the fixing unit is secured integrally with the heat dissipating module and the industrial computer by a plurality of fixing elements to integrate the heat dissipating module, the fixing units and the industrial computer as a whole structure with a three-axes locking design to prevent vibrations.

The technical characteristics of the present invention are described in details and illustrated with related drawings as follows:

### BRIEF DESCRIPTION OF THE DRAWINGS

FIG. 1 is an exploded view of a heat dissipating structure in accordance with the present invention;

FIG. 2 is an exploded view of a heat dissipating module in accordance with the present invention; and

FIG. 3 is an enlarged view of a fixing unit in accordance with the present invention.

### DETAILED DESCRIPTION OF THE INVENTION

In view of the shortcomings of the heat dissipating module that the industrial computer may cause tremendous inconvenience for the change of a heat dissipating module and produce vibrations that will affect the operation of the industrial computer, the present invention provides an improved heat dissipating structure to overcome the foregoing shortcomings of the prior art.

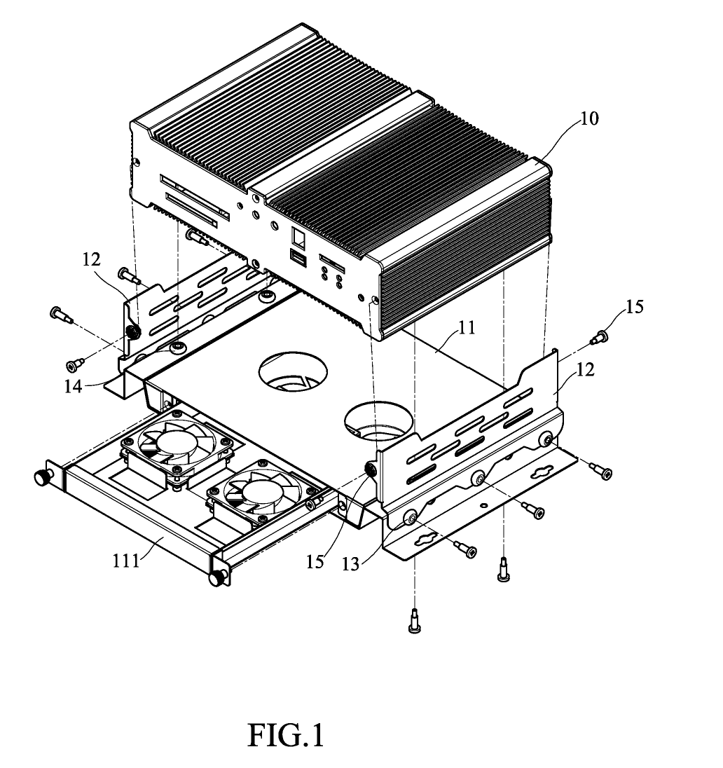

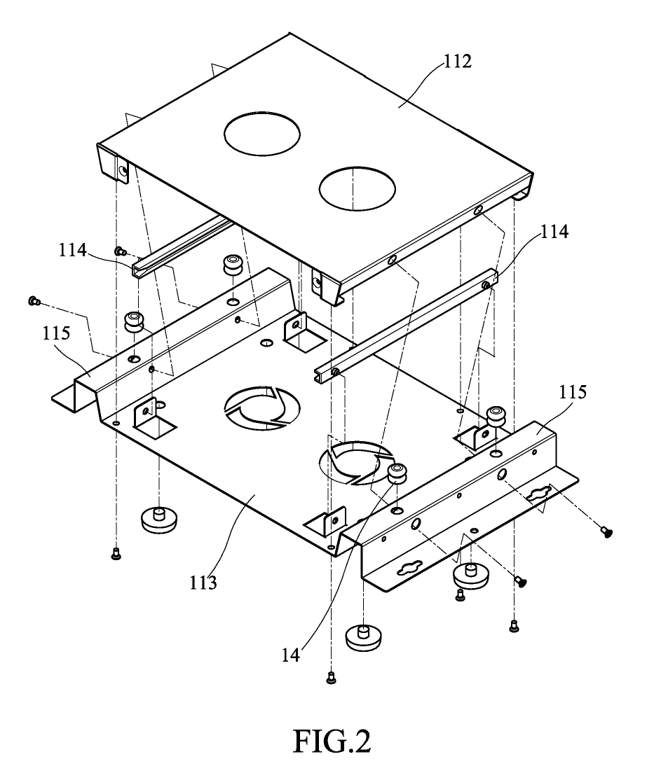

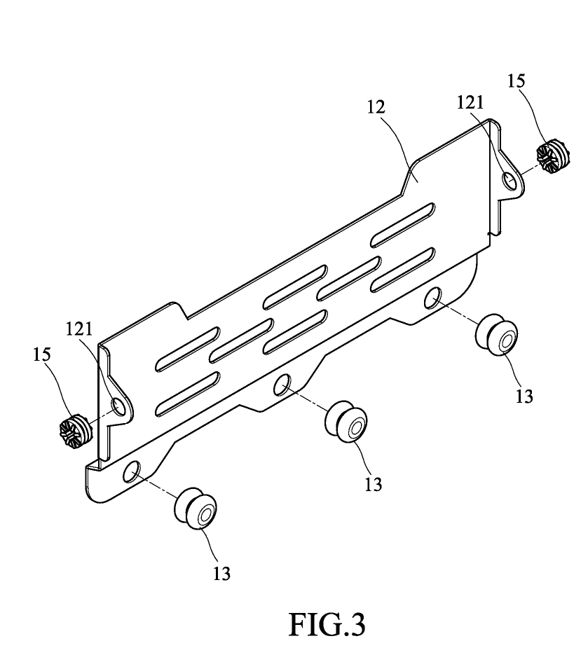

Refer to FIGS. 1 to 3 for an exploded view of a heat dissipating structure, an exploded view of a heat dissipating module and an enlarged view of a fixing unit in accordance with the present invention respectively, the heat dissipating structure of an industrial computer comprises a heat dissipating module 11 and two fixing units 12 installed on both lateral sides of a top surface of the heat dissipating module 11. The heat dissipating module 11 is comprised of an upper casing 112 and a lower casing 113, and a space is defined between the upper casing 112 and the lower casing 113 for installing a slide rail 114 and a heat dissipating fan module 111, such that the heat dissipating fan module 111 can slide on the slide rail 114 to constitute a detachable heat dissipating fan module 111. If the heat dissipating fan module 111 fails or has a poor efficiency due to the short life expectancy of the fan or the attachment of dusts from the air, a user can apply a force directly to detach the heat dissipating fan module 111 by sliding the heat dissipating fan module 111 along the slide rail 114 to a predetermined position without moving or removing the casing of the industrial compute, so that the user can replace the heat dissipating fan module 111 directly. After the replacement has been made, the user can push the heat dissipating fan module 111 along the slide rail 114 into a space (which is the interior of the heat dissipating module 11) defined between the upper casing 112 and the lower casing 113 to complete the replacement easily and conveniently.

Since the heat dissipating fan module 111 is rotated at a high speed to drive cold air into the industrial computer 10 for dissipating the heat, the high-speed rotation produces vibrations that will affect the normal operation of the industrial computer 10. Therefore, the present invention provides a three-axes fixing design to achieve a vibration-proof effect of the industrial computer 10. In the present invention, the heat dissipating structure of the industrial computer comprises a heat dissipating module 11 and two fixing units 12 installed on both lateral sides of a top surface of the heat dissipating module 11. Both lateral sides of the heat dissipating module 11 separately have a fixing base 115, and a lateral side of the fixing unit 12 is integrally secured with a lateral side of the fixing base 115 by a plurality of fixing elements 13, and a top side of the fixing base 115 is integrally secured with a bottom side of the industrial computer 10 by a plurality of fixing elements 14, and both lateral sides of the fixing unit 12 separately have a fixing protruded plate 121 for integrally securing the front, rear and lateral sides of the industrial computer 10 by a plurality of positioning elements 15. If the fixing base 115 and the fixing unit 12 of the heat dissipating module 11 are integrally secured with the industrial computer 10 by the fixing elements 13, 14, 15, a three-axes locking mode is formed. Even if there are vibrations produced during the high-speed rotation of the heat dissipating fan module 111 for the heat dissipation, the vibrations will be absorbed by the locking positions of the fixing base 115 and the fixing unit 12 of the heat dissipating module 11 with the industrial computer 10. In other words, the three axes including the x-axis, y-axis and z-axis of the industrial computer 10 will offset the action of the vibrations, so that the vibrations will not be transmitted to the industrial computer 10, and the invention definitely can achieve the vibration-proof effect.

To enhance the vibration-proof effect, the fixing element 13, 14, 15 can be designed as an element comprised of a rubber member and a screw, wherein the screw provides a locking function, and the rubber member provides a vibration absorbing function to improve the overall vibration-proof effect greatly.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An improved heat dissipating structure for an industrial computer, comprising a heat dissipating module and two fixing units installed on both lateral sides of a top surface of the heat dissipating module, characterized in that the heat dissipating module includes a detachable heat dissipating fan module disposed therein, and the fixing unit is secured integrally with the heat dissipating module and the industrial computer by a plurality of fixing elements.

2. The improved heat dissipating structure of an industrial computer as recited in claim 1, wherein the heat dissipating module is comprised of an upper casing and a lower casing, and a space is defined between the upper casing and the lower casing for installing a slide rail to slide the heat dissipating fan module on the slide rail.

3. The improved heat dissipating structure of an industrial computer as recited in claim 1, wherein the heat dissipating module includes a fixing base disposed separately on both sides of the heat dissipating module, and a lateral side of the fixing unit being integrally secured with a lateral side of the fixing base by a plurality of fixing elements, and a top side of the fixing base being secured with a bottom side of the industrial computer by a plurality of fixing elements, and both lateral sides of the fixing unit separately having a fixing protruded plate, such that the front, rear, and lateral sides of the industrial computer are secured by a plurality of positioning elements.

4. The improved heat dissipating structure of an industrial computer as recited in claim 3, wherein the fixing element is comprised of a rubber member and a screw.

5. An improved heat dissipating structure of an industrial computer, comprising a heat dissipating module and two fixing units installed on both lateral sides of a top surface of the heat dissipating module, characterized in that the heat dissipating module includes a detachable heat dissipating fan module disposed therein, and the fixing unit is integrally secured with the heat dissipating module and the industrial computer by a plurality of fixing elements, and the industrial computer is integrally secured with the heat dissipating module by a plurality of fixing elements.

6. The improved heat dissipating structure of an industrial computer as recited in claim 5, wherein the heat dissipating module is comprised of an upper casing and a lower casing, and a space is defined between the upper casing and the lower casing for installing a slide rail to slide the heat dissipating fan module on the slide rail.

7. The improved heat dissipating structure of an industrial computer as recited in claim 5, wherein the heat dissipating module includes a fixing base disposed separately on both sides of the heat dissipating module, and a lateral side of the fixing unit being integrally secured with a lateral side of the fixing base by a plurality of fixing elements, and a top side of the fixing base being secured with a bottom side of the industrial computer by a plurality of fixing elements, and both lateral sides of the fixing unit separately having a fixing protruded plate, such that the front, rear, and lateral sides of the industrial computer are secured by a plurality of positioning elements.

8. The improved heat dissipating structure of an industrial computer as recited in claim 7, wherein the fixing element is comprised of a rubber member and a screw.
